(19) United States
(12) Patent Application Publication
(10) Pub. No.: US 2005/0137880 A1
(43) Pub. Date: Jun. 23, 2005

(54) ESPR driven text-to-song engine

(75) Inventors: Thomas Alexander Bellwood, Austin, TX (US); Robert Bryant Chumbley, Austin, TX (US); Matthew Francis Rutkowski, Pflugerville, TX (US); Lawrence Frank Weiss, Round Rock, TX (US)

Correspondence Address: Gregory W. Carr, 670 Founders Square, 900 Jackson Street, Dallas, TX, 75202, US

(73) Assignee: International Business Machines Corporation, Armonk, NY (US)

(21) Appl. No.: 10/738,710

(22) Filed: Dec. 17, 2003

(51) Int. Cl. G10L 13/00

(52) U.S. Cl. 704/277

(57) ABSTRACT

A method, an apparatus, and a computer program are provided for deriving audio that includes singing by a human voice or chorus of voices. The audio is derived from an Enhanced Symbolic Phonetic Representation (ESPR) that incorporates symbolic representations of actions that are associated with singing, such as sustaining and vibrato. The audio output can also be as a result of operation of two types of programs: formant and concatenative.

### CROSS-REFERENCED APPLICATIONS

This application relates to co-pending U.S. patent applications entitled “METHOD FOR GENERATING AND EMBEDDING VOCAL PERFORMANCE DATA INTO A MUSIC FILE FORMAT” by Bellwood et al. (Docket No. AUS920030799US1), filed concurrently herewith.

### BACKGROUND OF THE INVENTION

1. Technical Field

The present invention relates generally to the operation of music support files and, more particularly, to the utilization of a vocal channel within a music support file.

2. Description of the Related Art

In 1983, musical instrument synthesizer manufacturers introduced an electronic format that greatly assisted in operation of synthesizers, the Music Instrument Digital Interface (MIDI) file format. MIDIs, though, are not limited to synthesizers. There are a variety of other devices that utilize MIDIs. For example, studio recording equipment and karaoke machines utilize MIDIs. Moreover, there are a variety of other music support file formats that can be utilized in addition to the MIDI. The MIDI file format, though, is the most well known of the music support file formats.

The MIDI format, as perhaps other music support file formats, are control files that describe time based instructions or events that can be read and sent to MIDI a processor. The instructions can include the note, duration, accent, and other playback information. Instructions can be grouped as “channels” that are mapped to suggested playback instruments.

Once the instructions are received, the processor correlates the instructions to the desired instrument and outputs sound because the processor contains samples of or a mathematical model of the given musical instruments. The MIDI file also supports global settings for tempo, volume, performance style, and other variables that apply to all channels or on the individual instruction events.

Typically, MIDI files utilize multiple channels, one for each instrument. For a general MIDI processor, there are approximately 128 channels, wherein each channel can correspond up to 128 different instruments. However, MIDI processors can have more or less than 128 channels. In essence then, a MIDI and other music support files operate as sheet music while the processor operates as an orchestra. Thus far, though, there has been one performance instrument that the MIDIs, other music support file formats, and processors have not incorporated into their electronic orchestra, the human voice.

To date, MIDIs, other music support file formats, and processors have only made correlations between a “note” and a recorded sound. There has not yet been a computer or a synthesizer where one could sit down at a keyboard, play a song and hearing a voice or chorus emanating from the speakers incorporating all the inflections, crescendos, etc.

Therefore, there is a need for a method and/or apparatus for creating and utilizing a music support file format incorporating a singing voice or chorus that addresses at least some of the problems associated with convention methods and apparatuses associated with music support file formats.

### SUMMARY OF THE INVENTION

The present invention provides an engine to derive audio output from a phonetic and musical representation, wherein the engine is configured to at least output audio data. Also, the phonetic and musical representation is input into the engine, wherein the phonetic and musical representation is at least enhanced to provide data corresponding to characteristics of singing. The phonetic and musical representation is interpreted by the engine and outputting an audio representation of an interpreted phonetic and musical representation, wherein the audio representation is configured to at least incorporate singing.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a block diagram depicting a system for utilizing of a Text-to-Song Engine;

FIG. 2 is a flow chart depicting a method for deriving audio output from a music support file in an Enhanced Symbolic Phonetic Representation (ESPR) through a formant algorithm; and

FIG. 3 is a flow chart depicting a method for deriving audio output from a music support file in an ESPR through a concatenative algorithm.

### DETAILED DESCRIPTION OF THE INVENTION

In the following discussion, numerous specific details are set forth to provide a thorough understanding of the present invention. However, those skilled in the art will appreciate that the present invention can be practiced without such specific details. In other instances, well-known elements have been illustrated in schematic or block diagram form in order not to obscure the present invention in unnecessary detail. Additionally, for the most part, details concerning network communications, electro-magnetic signaling techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein can be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise.

In the remainder of this description, a processing unit (PU) can be a sole processor of computations in a device. In such a situation, the PU is typically referred to as an MPU (main processing unit). The processing unit can also be one of many processing units that share the computational load according to some methodology or algorithm developed for a given computational device. For the remainder of this description, all references to processors shall use the term MPU whether the MPU is the sole computational element in the device or whether the MPU is sharing the computational element with other MPUs, unless indicated otherwise.

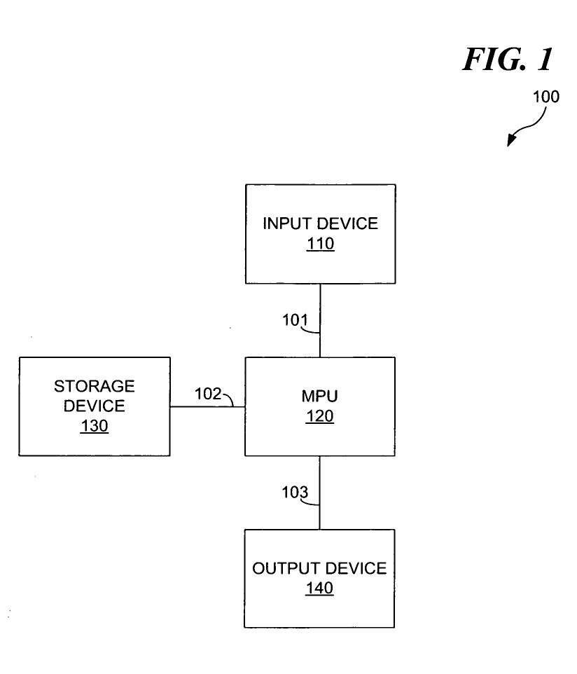

Referring to FIG. 1 of the drawings, the reference numeral 100 generally designates a system utilizing a Text-to-Song Engine. The system 100 comprises an input device 110, an MPU 120, a storage device 130, and an output device 140.

Generally, the utilization system 100 operates based on the use of SPR data that is further encoded with musical representations to yield ESPR data. SPR is a phonetic representation of words for use in computer systems, more particularly speech synthesis systems. For example, ViaVoice™ uses an SPR system. However, there are a variety of software packages that utilize a variety of phonetic representations. These software packages operate by creating a correspondence between phonetic voice data and a table of sampled voice segments or voice algorithms to create or synthesize vocal output.

However, the utilization system 100 can operate on SPR data or ESPR data. There are three categories of enhancements to the SPR data to yield the ESPR data: musical data, performance data, and other data.

With the musical data enhancements, the ESPR data includes several symbolic representations that are more closely related to vocalizations associated with music in addition to other phonetic representations normally associated with SPR data. A variety of symbolic representations more closely related to singing can be added to SPR data to yield ESPR data. For example, notes, control of length of time segments to allow for a dynamic tempo and control of periods of rests can be added. Also, there can be symbolic representation for the sustaining of voiced parts of words in expressed time segments and for vibratos. Symbolic information relating to volume or intensity can also be added that would allow for specific representation of crescendos and the like. There are a variety of enhancements that correspond to a variety of well-known musical notations and representations that can be utilized.

Moreover, with the performance data enhancements, symbolic control values for a specific vocalization can be included to express melodic behavior of the vocalizations defining varying singing styles. More particularly, ESPR data can contain indicators that identify a particular vocalist uniquely. For example, the ESPR can contain an indicator identifying the singing style of Maria Callas or of Aretha Franklin. Also, Environment Modeling Annotations can be added to account for the specific venue upon which a given vocalization occurs, like reverb. There are a variety of enhancements that correspond to a variety of performance notations and representations that can be utilized.

With the other data enhancements, a variety of other control data is incorporated into the ESPR data. More particularly, the other data enhancements can allow for the instructions corresponding to storage, to streaming, or to processing. For example, the other data enhancements can include data that is embedded in a MIDI file.

More particularly, when the ESPR data is embedded in a MIDI file, the ESPR data can have characteristics that correspond to MIDI. Firstly, the ESPR data embedded into a MIDI file can be encoded as one or more lyric events. Also, existing MIDI processors will be able to process a MIDI file with the embedded ESPR data. In other words, an existing MIDI processor will be able to perform all of the music in the MIDI, but the MIDI processor may not necessarily be able to interpret the vocal performance. The recognition of embedded ESPR is accomplished through the use of a control sequence or header that indicates ESPR as part of a lyric event. Also, the control sequence can indicate a corresponding channel with additional musical data that allows for ESPR performance. This corresponding channel can be a subset of the ESPR data for the purpose of correlation. There is a variety of other control data that can be embedded into a control sequence or header, and the above mentioned examples are meant for the purposes of illustration. Moreover, similar correlations and embedding procedures can be accomplished with a variety of other musical file formats.

The input device 110 encompasses a variety of input devices. For example, a keyboard, mouse, or synthesizer keyboard can be utilized to input desired musical notation. Also, the input device 110 is coupled to the MPU 120 through a first communication channel 101. Moreover, any of the aforementioned communications channels through a network configuration would encompass wireless links, packet switched channels, direct communication channels and any combination of the three.

The MPU 120 can be a variety of processors. The MPU 120 decodes an ESPR file and outputs an audio signal. For example, a general-purpose computer or a dedicated musical composition computer can be utilized to generate audio as desired from ESPR data. Moreover, the MPU 120 can be the component most responsible for correlating and generating audio, specifically with a human voice singing, from a given, desired algorithm.

The storage device 130 can encompass a variety of devices, such as a Hard Disk Drive (HDD). The storage device 130 stores the ESPR file, which had been previously encoded. Moreover, the MPU 120 can receive information from storage (as shown), transfer though a communications network, or any combination of the two. Also, the storage device 130 is coupled to the MPU 120 through a second communication channel 102. Moreover, any of the aforementioned communications channels through a network configuration would encompass wireless links, packet switched channels, direct communication channels and any combination of the three.

The output device 140 can encompass a variety of output devices for generating audio. The output device 140 receives an audio signal from the MPU 120. For example, sound cards with audio outputs like Sound Blaster®, karaoke machines, and studio equipment all have the capability of outputting audio. The utilization system 100 can include all or any combination of methods and apparatus for generating audio outputs. Also, the output device 140 is coupled to the MPU 120 through a third communication channel 103. Moreover, any of the aforementioned communications channels through a network configuration would encompass wireless links, packet switched channels, direct communication channels and any combination of the three.

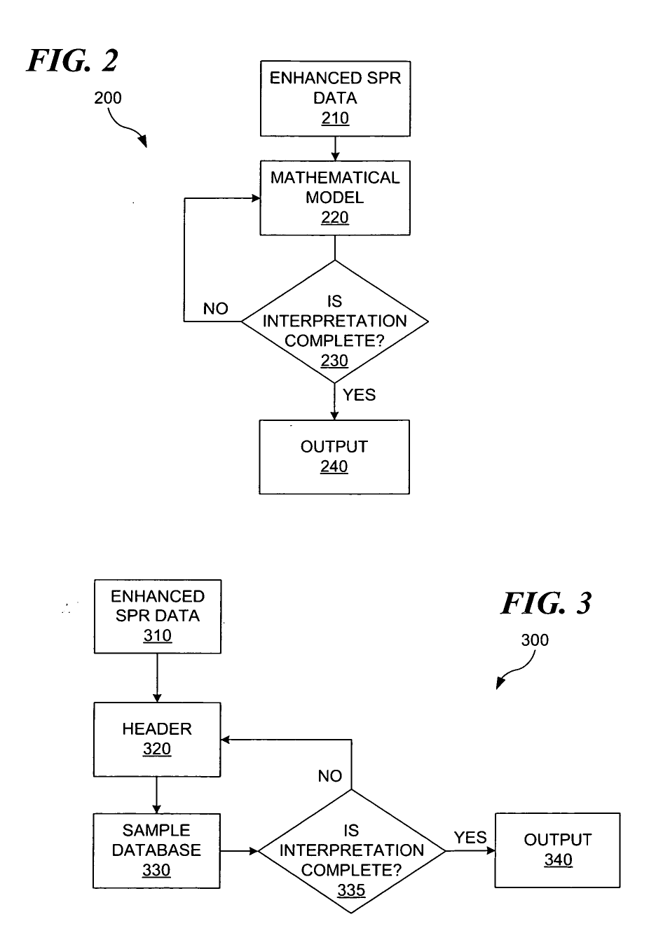

Now referring to FIG. 2 of the drawings, the reference numeral 200 generally designates a flow chart illustrating a method for deriving audio output from ESPR data with a formant algorithm. The MPU 120 of FIG. 1 relies on a formant algorithm or a mathematical model of the vocalization to be presented. The mathematical model that is the formant algorithm predicts frequency, timing, etc. of a voice or instrument with given characteristics derived from the data embedded in the ESPR data.

In step 210, the flow chart 200 begins by receiving ESPR data. The ESPR data can be retrieved from storage device 130 of FIG. 1, transferred though a communications network, or any combination of the two by the MPU 120 of FIG. 1. The ESPR data can also be directly inputted to the MPU 120 of FIG. 1 through the input device 110 of FIG. 1.

In steps 220 and 230, once the ESPR data has been received by the given MPU 120 of FIG. 1, then the ESPR data is interpreted by the MPU 120 of FIG. 1. In this case, the formant algorithm is based on a given human voice singing, and the formant algorithm can be retrieved from storage, transferred though a communications network, or any combination of the two by the MPU 120 of FIG. 1. Although, the formant algorithm produces a lower quality output, it is more compact and is less expensive. Hence, Text-to-Song Engines utilizing a formant algorithm could be marketed to general consumers for musical composition incorporating a signing human voice in embedded devices and/or at a lower cost.

In step 240, the MPU 120 of FIG. 1 outputs the audio. To date, there are a number of methods and apparatuses for outputting audio, including song. For example, sound cards with audio outputs like Sound Blaster®, karaoke machines, and studio equipment all have the capability of outputting audio. The Text-to-Song Engine can include all or any combination of methods and apparatus for generating audio outputs.

Now referring to FIG. 3 of the drawings, the reference numeral 300 generally designates a flow chart illustrating a method for deriving audio output from ESPR data with a concatenative algorithm. The MPU 120 of FIG. 1 relies on a concatenative algorithm or a sample database of the instrument to be broadcasted. The concatenative algorithm splices sections of sound from a sound database of a given singing voice to yield the desired output.

In step 310, the flow chart 300 begins by receiving ESPR data. The ESPR data can be retrieved from a storage device 130 of FIG. 1, transferred though a communications network, or any combination of the two by the MPU 120 of FIG. 1. Typically, in existing Text-To-Speech SPR data, there are specific symbols, which a consumer of this data, such as ViaVoice™, would interpret as a phonetic representation of spoken output. However, ESPR data is significantly different in that there is specific data added to the SPR data to allow for the derivation of a sung vocalization.

In steps 320, 330, and 335, once the ESPR data has been received by the given MPU 120 of FIG. 1, then the ESPR data is interpreted by the MPU 120 of FIG. 1. The MPU 120 of FIG. 1 relies on a concatenative algorithm or a sample database of the sung voice to be output. The concatenative algorithm splices sections of sound from a sound database of a given singing voice to yield the desired output. In this case, the concatenative algorithm is based on a given human voice singing. In an example of a Text-to-Song Engine, the MPU 120 of FIG. 1 accesses a header file that directs a pointer to a specific audio database location. From there, the sample data is retrieved and spliced with other samples to generate the sung output. The sample data can be retrieved from storage, transferred though a communications network, or any combination of the two by the MPU 120 of FIG. 1. Note that, while the concatenative algorithm produces a higher quality output, it is generally larger and is generally less suitable for environments with constrained resources, such as embedded devices. Hence, a Text-to-Song Engine utilizing a concatenative algorithm could be marketed to more sophisticated consumers for musical composition incorporating a signing human voice with a high degree of quality.

The reason for there being a higher degree of quality is due to the data base entries. With a concatenative algorithm, a person would be required to sign various vocalizations that would be recorded that could number in hundreds or in the thousands. With the enormous amount of data generated from vocalizations, a large database could provide artificial vocalizations, as a result of splicing, where errors would not be as noticeable.

In step 340, the MPU 120 of FIG. 1 generates audio data. To date, there are a number of methods and apparatuses for outputting audio. For example, sound cards with audio outputs like Sound Blaster®, karaoke machines, and studio equipment all have the capability of presenting sung data. The Text-to-Song Engine can include all or any combination of methods and apparatus for generating song outputs.

It will further be understood from the foregoing description that various modifications and changes can be made in the preferred embodiment of the present invention without departing from its true spirit. This description is intended for purposes of illustration only and should not be construed in a limiting sense. The scope of this invention should be limited only by the language of the following claims.

1. A method for an engine to derive audio output from a phonetic and musical representation, wherein the engine is configured to at least output sung audio data, comprising:
inputting the phonetic and musical representation to the engine, wherein the phonetic and musical representation is at least enhanced to provide data corresponding to characteristics of singing;
interpreting the phonetic and musical representation by the engine; and
outputting an audio representation of an interpreted phonetic and musical representation, wherein the audio representation is configured to at least incorporate singing.

2. The method of claim 1, wherein interpreting further comprises:
accessing a program, wherein the program is configured to at least correlate the musical and phonetic representation into audio by mathematical interpretation to at least produce singing;
applying the program to the phonetic and musical representation to produce the audio representation.

3. The method of claim 1, wherein interpreting further comprises:
accessing a pointer, wherein the pointer is configured to at least correlate the musical and phonetic representation into audio to at least produce singing;
pointing to an audio sample in a data base, wherein the audio sample is configured to at least contain singing; and
splicing the audio samples together to produce the audio representation.

4. The method of claim 1, wherein the phonetic and musical data further comprises:
musical data for instruments;
enhanced phonetic linguistical data for singing comprising symbolic representation for at least vocal singing controls.

5. An apparatus to derive audio output from a phonetic and musical representation, wherein an engine is configured to at least output audio data, comprising:
means for inputting the phonetic and musical representation to the engine, wherein the phonetic and musical representation is at least enhanced to provide data corresponding to characteristics of singing;
means for interpreting the phonetic and musical representation by the engine; and
means for outputting an audio representation of an interpreted phonetic and musical representation, wherein the audio representation is configured to at least incorporate singing.

6. The apparatus of claim 5, wherein the means for interpreting further comprises:
means for accessing a program, wherein the program is configured to at least correlate the musical and phonetic representation into audio by mathematical interpretation to at least produce singing;
means for applying the program to the phonetic and musical representation to produce the audio representation.

7. The apparatus of claim 5, wherein the means for interpreting further comprises:
means for accessing a pointer, wherein the pointer is configured to at least correlate the musical and phonetic representation into audio to at least produce singing;
means for pointing to an audio sample in a data base, wherein the audio sample is configured to at least contain singing; and
means for splicing the audio samples together to produce the audio representation.

8. The apparatus of claim 5, wherein the phonetic and musical data further comprises:
musical data for instruments;
enhanced phonetic linguistical data for singing comprising symbolic representation for at least vocal singing controls.

9. A computer program product for an engine to derive audio output from a phonetic and musical representation, wherein the engine is configured to at least output audio data, the computer program product having a medium with a computer program embodied thereon, the computer program comprising:
computer program code for inputting the phonetic and musical representation to the engine, wherein the phonetic and musical representation is at least enhanced to provide data corresponding to characteristics of singing;
computer program code for interpreting the phonetic and musical representation by the engine; and
computer program code for outputting an audio representation of an interpreted phonetic and musical representation, wherein the audio representation is configured to at least incorporate singing.

10. The computer program code product of claim 9, wherein the computer program code for interpreting further comprises:
computer program code for accessing a program, wherein the program is configured to at least correlate the musical and phonetic representation into audio by mathematical interpretation to at least produce singing;
computer program code for applying the program to the phonetic and musical representation to produce the audio representation.

11. The computer program code product of claim 9, wherein the computer program code for interpreting further comprises:
computer program code for accessing a pointer, wherein the pointer is configured to at least correlate the musical and phonetic representation into audio to at least produce singing;
computer program code for pointing to an audio sample in a data base, wherein the audio sample is configured to at least contain singing; and
computer program code for splicing the audio samples together to produce the audio representation.

13. A processor for providing an engine to derive audio output from a phonetic and musical representation, wherein the engine is configured to at least output audio data, the processor including a computer program comprising:
computer program code for inputting the phonetic and musical representation to the engine, wherein the phonetic and musical representation is at least enhanced to provide data corresponding to characteristics of singing;
computer program code for interpreting the phonetic and musical representation by the engine; and
computer program code for outputting an audio representation of an interpreted phonetic and musical representation, wherein the audio representation is configured to at least incorporate singing.

14. The computer program code product of claim 13, wherein the computer program code for interpreting further comprises:
computer program code for accessing a program, wherein the program is configured to at least correlate the musical and phonetic representation into audio by mathematical interpretation to at least produce singing;
computer program code for applying the program to the phonetic and musical representation to produce the audio representation.

15. The computer program code of claim 13, wherein the computer program code for interpreting further comprises:
computer program code for accessing a pointer, wherein the pointer is configured to at least correlate the musical and phonetic representation into audio to at least produce singing;
computer program code for pointing to an audio sample in a data base, wherein the audio sample is configured to at least contain singing; and
computer program code for splicing the audio samples together to produce the audio representation.

16. The computer program code of claim 13, wherein the phonetic and musical data further comprises:
musical data for instruments;
enhanced phonetic linguistical data for singing comprising symbolic representation for at least vocal singing controls.
